(19) United States
(12) Patent Application Publication
(10) Pub. No.: US 2016/0119399 A1
(43) Pub. Date: Apr. 28, 2016

(54) EXTENDING BROWSER SUPPORT OF REAL TIME MEDIA TO ANY AVAILABLE CODEC

(71) Applicant: Kevin J. Glass, Cardiff (GB)

(72) Inventor: Kevin J. Glass, Cardiff (GB)

(21) Appl. No.: 14/523,235

(22) Filed: Oct. 24, 2014

(51) Int. Cl. H04L 29/06; H04N 19/44; H04L 29/08

(52) U.S. Cl. CPC H04L 65/608; H04L 67/141; H04L 65/607; H04N 19/44

(57) ABSTRACT

Method for extending web browser support to include real-time media having any media compression scheme without the need for media plugins. The method involves receiving at a web client computing device a web page resource hosted by a server. The web page resource includes an embedded script which defines a codec for real-time media communications. Thereafter, a real-time media session as between the web client and a remote computing device involves receiving at the web client real-time media data originating from the remote computing device, and performing media encoding at the web client within a web browser application using the at least one script to convert the video data from the first media coding scheme to an unencoded media format.

### BACKGROUND OF THE INVENTION

1. Statement of the Technical Field

The inventive arrangements relate to media support in commercially available browsers, and more particularly to media support used in such browsers to facilitate a communication session with enterprise end-points.

2. Description of the Related Art

There is a growing trend among businesses and other entities for the inclusion of media in their consumer-facing web-sites. For example, many such organizations now offer marketing, sales and/or support interactions with consumers through interactive media sessions. Such media sessions can include interactive audio media sessions in which a consumer speaks with and can hear a customer representative through an interactive internet browser session. Such media sessions can also include video type media sessions during which the consumer can see live video images of the customer service representative, and the customer service representative can see the consumer.

An interactive media session as described herein often uses a microphone and an image capture device, such as a digital camera. The voice and video information captured by these devices is digitally encoded at the source location before being communicated over the internet in the form of digital data. In order to facilitate real time communications, various data compression methods are commonly used as part of the encoding process. At the receiving end of the communication link, the compressed digital data must be decoded and/or decompressed in order to extract the audio and/or video information. Computing equipment is commonly used by each party participating in the interactive media session to facilitate the various communication protocols associated with the session. The computing equipment will generally include at least one coder-decoder device (commonly known as a codec) at each location participating in the media session which is designed to perform the digital encoding and decoding operations described above.

WebRTC is a standards-based approach to enabling real time communications through a common set of APIs. These APIs were created as part of HTML5 and meant to provide simplified way for web developers to embed communications within their web sites and applications without knowing the complexities of Voice over IP. As such, WebRTC facilitates sending and receiving of real-time media by allowing users to access a web page and then use that web page to make an audio or video call. Media is subsequently sent directly to and from the web browser without the need for intermediary transcoding hardware at the enterprise end. WebRTC defines a way for browsers to implement technologies like video conferencing in a way that is both interoperable with other clients and does not require the use of a plugin. Notably, WebRTC includes audio and video codecs such as G.711, iLBC, Opus and VP8. WebRTC is increasingly supported in popular internet browser platforms.

An advantage of WebRTC is that it contains as set of basic building blocks that are needed for high quality communications over the internet. Notably, these building blocks include various elements such as network, audio and video components which can be used to facilitate voice and video chat applications. For example, WebRTC includes a complete software solution stack for voice communications. The WebRTC standard does not include or mandate use of any specific video compression format. However, it does require that applications (such as web browser) implementing WebRTC do include at least some type of video codec for video encoding. For purposes of WebRTC, the specific video compression protocol is not critical. Instead, what is key is that the stack needed for transporting video data is present on the web application (e.g. web browser).

Currently two video codecs (“coder-decoder”) dominate the communications industry for video conferencing: H.264 and VP8. One candidate for the standard video codec in WebRTC is the VP8 video compression standard. VP8 is open source and royalty free compression standard. It has gained wide support from the web world because of its free nature and tends to be the prime choice of open source communities. A second video compression format which can be used in WebRTC is H.264. The H.264 video compression format is also known by the name MPEG Part 10, Advanced Video Coding (or MPEG-4 AVC). The H.264 video compression format is extensively used in consumer and industry devices for purposes of recording, compressing, and distributing video content. In fact, most enterprise equipment used to facilitate interactive video media sessions with consumers are known to rely on H.264 as their video compression format. Unfortunately, only some web applications support H.264, whereas others support VP8 or other types of video codecs.

For security purposes, all WebRTC communications are encrypted before leaving the web client computing device. Two protocols are used for this purpose. Datagram Transport Layer Security (DTLS) is used to facilitate a secure signaling channel between the web client and the remote media server. DTLS is used exclusively for signaling whereas a second security protocol is provided for secure transport of media (e.g., audio and video). Specifically, WebRTC implements the well-known Secure Real-Time Protocol (SRTP), which is an encrypted profile of conventional RTP.

Because of the advantages associated with WebRTC, many application developers (such as web-browser developers) are encouraged to create web-based application software implementing the WebRTC standard. Still, the lack of consensus under the WebRTC standard with regard to video compression format means that there can be no assurance that existing enterprise equipment (which most commonly relies upon H.264 codecs) will be compatible with the new WebRTC based web applications, such as web browsers.

In the absence of such video codec compatibility, enterprise developers are forced to provide transcoder hardware and software that is capable of converting streaming video media from one compression format to a second compression format. Since most enterprise equipment utilizes H.264 codecs, the transcoders will typically need to convert the H.264 encoded video data to a different compression format, such as VP8.

The WebSocket specification defined by the Internet Engineering Task Force (IETF) defines a JavaScript API that enables web pages to use a WebSocket protocol to facilitate full duplex single socket two-way communication with a remote host. The WebSocket specification was developed as part of the HTML5 initiative and was designed to simplify the complexities associated with bi-directional web communication and connection management. In accordance with the WebSocket API, a WebSocket connection is established when the client computing device and a remote server upgrade from the HTTP protocol to the WebSocket protocol. These actions are takend during their initial HTTP handshake routine. Once the WebSocket protocol is established, WebSocket data frames can be communicated bi-directionally in full duplex as between the client and server computers. Notably, the WebSocket API facilitates communication of both text and binary data frames, and such data is advantageously framed with only two bytes of data.

### SUMMARY OF THE INVENTION

Embodiments of the invention concern a method for extending web browser support to include real-time media having any media compression scheme without the need for media plugins. The method involves receiving at a web client computing device a web page resource hosted by a server. The web page resource includes an embedded script which defines a codec for real-time media communications, such as real-time video media communication. The web page resource can be an HTML page and the at least one script can be a JavaScript type script, where the script is executed by a JavaScript engine included in a web browser. Once the script is received at the browser, a real-time media session as between the web client and a remote computing device involves receiving at the web client real-time media data originating from the remote computing device, and performing media decoding at the web client within the web browser application, using the at least one script to convert the video data from the first media coding scheme to a decoded format. The method further involves encoding real-time media data originating at the web client by using the codec to convert non-encoded real-time media data to the first media coding scheme. According to one aspect of the invention, the first media encoding scheme can include a video data compression scheme, such as H.264.

According to one aspect of the invention, a WebSocket communication channel is advantageously established as between the web client and at least one server. Thereafter, bi-directional communication of the real-time media in an encoded form can be conducted as between the web client and the at least one server using the WebSocket channel. A separate WebSocket communication channel can be established for media signaling operations. Alternatively, a WebRTC data channel could be used for these purposes.

The web browser described herein is advantageously one that supports WebRTC. In that case, the method can further include receiving at the web client a second type of real-time media which uses a second encoding scheme which is supported by at least one native WebRTC codec. For example, the second type of real-time media can be audio media data which is compressed in accordance with an audio compression scheme.

### BRIEF DESCRIPTION OF THE DRAWINGS

Embodiments will be described with reference to the following drawing figures, in which like numerals represent like items throughout the figures, and in which:

FIG. 1 is a conceptual diagram that is useful for understanding a computer architecture used for supporting video media communications as between a web client and an enterprise video communication device.

FIG. 2 is a drawing that is useful for understanding a web client computing device.

FIG. 3 is a drawing that is useful for understanding a web browser software application.

FIG. 4 is a drawing that is useful for understanding certain communication protocols that are used to support a video communication session.

FIG. 5 is a conceptual drawing that is useful for understanding an alternative embodiment of the inventive arrangements described herein with respect to FIG. 1.

FIG. 6 is a drawing that is useful for understanding a computing device which can be used in a real-time media communication session.

### DETAILED DESCRIPTION

The invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

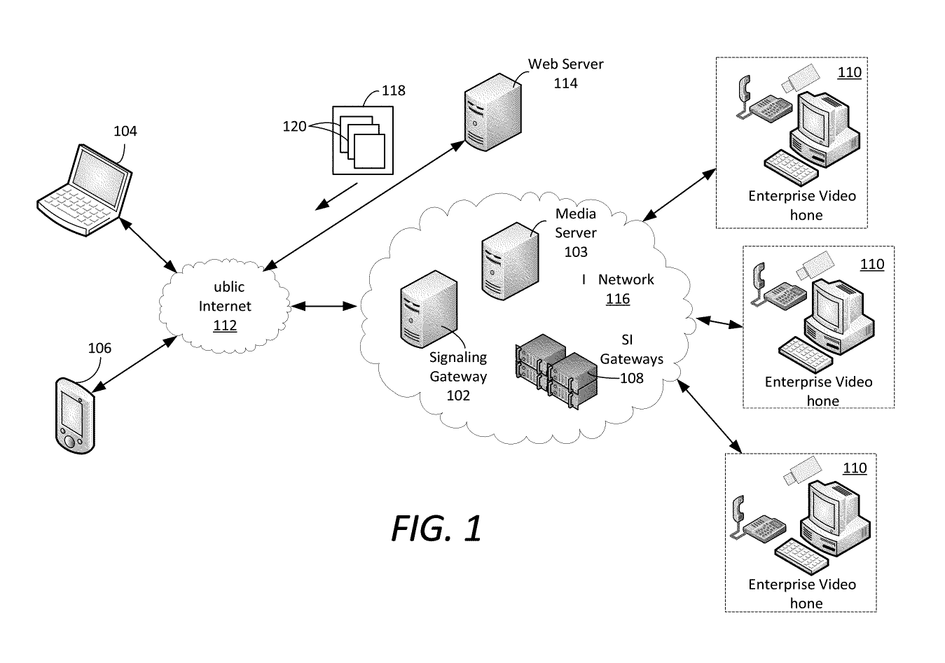

Referring now to FIG. 1 there is shown simplified architecture of an interactive communication system that facilitates one or more concurrent video media sessions with a plurality of end-user devices. The end-user devices can include any one of a variety of web client computing devices such as computer 104 and a smart-phone 106. The end user devices can communicate with a web server 114. For example, the web server 114 can receive HTTP requests from web client computing devices 104, 106 and translate received URL requests to identify specific web pages which are to be served to such devices. The web server 114 can also support various web services and standards which are useful for carrying out the functions described herein. For example, the server can support authentication of web clients, file transfer and so on. In some embodiments, the web server 114 can be included within a private IP network 116 as described below, but the invention is not limited in this regard.

The end user devices also communicate with remote computing devices such as enterprise video phones 110 which support one or more interactive live video media or video streaming sessions through public Internet 112 and IP network 116. Enterprise based video phones are one common source of video communications which are useful for understanding the inventive arrangements. Still, it should be appreciated that the invention described herein is not limited to use with video phones as shown. Instead, the remote computing devices at the enterprise level can include any device which is capable of generating and or communicating a stream of video data (e.g., real-time video data).

The IP network 116 can include several interconnected components. For example, the IP network 116 can include one or more SIP Gateways 108. As is known in the art, SIP (Session Initiation Protocol) is a commonly utilized signaling communications protocol for IP-based streaming multimedia services in cellular communications systems. SIP can be used for creating, modifying and terminating sessions consisting of one or several media streams. For example, the protocol is often used for control of multimedia communication sessions such as voice and video calls over IP networks such as the Internet. The SIP gateways 108 provide a secure edge device that let network external SIP signaling into the internal network. Similar to a firewall. The SIP gateways are also sometimes referred to as SBC (Session Border Controllers).

Also included in private IP network 116 is a media server 103. Conceptually, the media server 103 performs different functions as compared to the web server 114. However, in certain practical implementations, it can be convenient to merge the functions of web server 114 and media server 103 within one common server.

In conventional systems, a commercially available web browser executing on a user device (such as computer 104 and/or smart-phone 106) would require a media server (e.g. media server 103) to perform media transcoding so that the video compression format of compressed video data is compatible with the codecs in both the web clients and enterprise video phones. The H.264 video compression format is extensively used in consumer and industry devices for purposes of recording, compressing, and distributing video content. In fact, most enterprise equipment used to facilitate interactive video media sessions with consumers are known to rely on H.264 as their video compression format. Unfortunately, only some web applications support H.264, whereas others support VP8 or other types of video codecs. Accordingly, in a conventional enterprise architecture which facilitates one or more video streaming sessions, the media server must provide media transcoding functionality to transcode compressed video streaming data from one video compression format to a different video compression format. For example, the transcoding operation would convert the compressed video stream from enterprise video phones 110 into a suitable format so that it can be processed by end-user computing devices such as computer 104 and a smart-phone 106. Likewise it would convert a compressed video stream from computer 104 and smart phone 106 to a format which can be understood by enterprise video phones 110.

The private IP network 116 can further include a signaling gateway 102. The signaling gateway 102 performs transcoding operations for signaling to support interoperability of user computing devices 104, 106 with different modes of signaling that may be used within the IP network 116. As is known in the art, such signaling can be used for creating, modifying and terminating video media sessions.

The media transcoding performed by a conventional media server is highly processing intensive and consumes substantial resources. In fact, transcoder processing limitations can often be a limiting factor in the number of concurrent media sessions which can be supported by an enterprise interactive media system. Conventional enterprise systems that are designed to concurrently support interactive video streaming sessions with multiple end users can require multiple servers to support the necessary transcoding operations. The invention described herein advantageously eliminates the need for such media transcoding in a manner that is secure and flexible, thereby allowing web clients to participate in live media communication sessions using any media compression scheme that may be implemented at a remote computing device.

One possible way to reduce the enterprise burden associated with transcoding operations is to provide suitable codecs to the user computing devices, such as computer 104 and smart-phone 106. For example, in the past a browser plug-in has sometimes been used at the client computer device 104, 106 to perform these codec operations. As is known in the art, a plugin is a software component which can be downloaded by a user to increase functionality of a web browser. For example, browser plugins are available to facilitate display of additional content on a web browser that the web browser was not originally designed to display. Accordingly, a codec in the form of a plugin can be downloaded and installed by a user to facilitate a streaming video session between a web browser and an enterprise system that utilizes a particular video compression format.

Still, there is a problem with use of plugins in client computing devices insofar as they are known to present substantial security risks. In fact, security problems with browser plugins have become so acute that developers of many modern web browsers have entirely removed support for such plugins, or plan to eliminate such support in the future. Accordingly, enterprise system designers cannot count on the availability of browser plugins for purposes of ensuring video encoding compatibility with client computing devices.

JavaScript is a well-known client-side scripting language which is actually written into an HTML web page. An HTML web page which is served to a client web browser can and often does include JavaScript within the page. When the script is received by the web browser it will be processed by the browser. A JavaScript interpreter on a client web browser will recognize and attempt to execute the script so as facilitate certain scripted actions. These actions are commonly known to include changes to certain HTML elements such as forms, images, layers, paragraphs and so on. For example, JavaScript is commonly used to control display of advertisements on HTML websites. The scripts are generally designed to be executed automatically by the JavaScript interpreter after the HTML page is loaded on a client computer and/or when an operator interacts with the web page in a certain way.

WebGL (Web Graphics Library) is an Application Programming Interface (API) or software library that is provided in JavaScript and enabled in many modern web browsers. WebGL extends the capability of the JavaScript programming language by facilitating rendering of interactive 3D graphics and 2D graphics within a web browser without the use of browser plug-ins. Notably, WebGL elements can be mixed or combined with other HTML elements within a web page. Accordingly, the WebGL elements can be interspersed or displayed with other elements comprising the HTML page. The WebGL API is responsive to control code that is written in JavaScript.

According to one aspect of the invention, a web client device will communicate with a web server 114. The web server 114 will receive one or more HTTP requests from web client computing devices 104, 106 and translate received URL requests to identify specific web pages which are to be served to such devices. At least one web page 118 which is served is comprised of HTML or comparable markup language but also include certain scripts 120 which are executable by a script interpreter or engine at the web client. For example, the scripts can be written in the well-known JavaScript language and can be interpreted by a JavaScript engine. The scripts which are downloaded as part of the web page can include a codec for coding and decoding a live media data stream, such as a video data stream and/or an audio data stream. The scripts can also include signaling components that facilitate setup, maintenance and termination of the live media data stream as hereinafter described.

According to one aspect, the JavaScript based video codec is designed to use the well known WebGL API to display the decoded video. The foregoing approach provides a framework by which a web browser (e.g. a web browser in a client computing device such as computer 104 or smart-phone 106) can be automatically provided with an appropriate codec for any media encoded format as part of an HTML page. With the foregoing arrangement, there is no longer a need to perform video transcoding at a media server 103, thereby greatly reducing processing resources needed at the enterprise level. Instead, fully compatible coding and decoding is performed at the client or user computing device (e.g. a laptop, smartphone or tablet application) that connects to an enterprise endpoint, regardless of what video compression scheme is being used by the enterprise endpoint. The need for transcoding is thus eliminated.

The downloaded web page can include scripts (e.g., scripts executable by a JavaScript engine) which are advantageously designed to establish communications channels to be used during a live media communication session. For example, the scripts can establish communications channels between the web browser and one or more enterprise endpoints. These communications channels can be used for media and/or signaling. According to one embodiment, the scripts can establish a data communication channel using an RTCDataChannel API which is available in WebRTC. The RTCDataChannel API facilitates the establishment of data channels with remote endpoints and supports a flexible set of data types. Accordingly, such data channels can be used for signaling and/or media transport during a real-time media communication session. Such media can include audio media data and/or video media data. Accordingly, a web browser that supports WebRTC can communicate with a signaling gateway 102 (sometimes referred to herein as a signaling transcoder) and or a media server 103 using WebRTC data channels. Alternatively, WebRTC dependencies can be reduced by utilizing a communication channel or channels implemented using WebSockets. The approaches described herein remove the need to use other types of conventional data transmission protocols for video transmission (such as User Datagram Protocol (UDP) or Real-time Transport Protocol (RTP) over TCP (Transmission Control Protocol)).

The downloaded web page from the web server 114 can further include scripts (e.g., scripts executable by a JavaScript engine) which are designed to execute signaling operations at the web client during a live media communication session (e.g. during a video media communication session). The scripts can execute a basic signaling protocol to assist in initiating, maintaining, and terminating a live media communication session. The operation of the various scripts described herein will explained below in further detail.

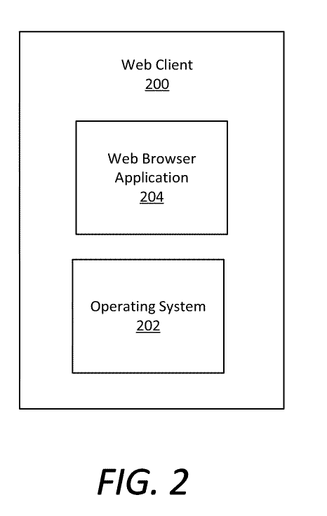

FIG. 2 is a drawing that is useful for understanding a web client 200 which can be used to facilitate a streaming video chat session with an enterprise-based video phone. The web client 200 is comprised of a combination of hardware and software elements capable of carrying out the streaming video functions and operations described herein. The hardware associated with the client computing device can include without limitation a personal computer, a tablet computer, a personal digital assistant and/or a smart-phone. The web client will include an operating system 202 and suitable software, such as a web browser 204 that is capable of communicating HTTP requests to web servers. The web browser 204 will support various web services and standards which are useful for carrying out the functions and operations described herein. For example, the web browser provided in web client 200 can support real time communications by means of a supported API such as WebRTC. The web browser application 204 also supports user and device authentication, static and dynamic displays associated with web pages, file transfers and so on. As will be appreciated by those skilled in the art, many combinations of hardware and software are possible for purposes of implementing the web client.

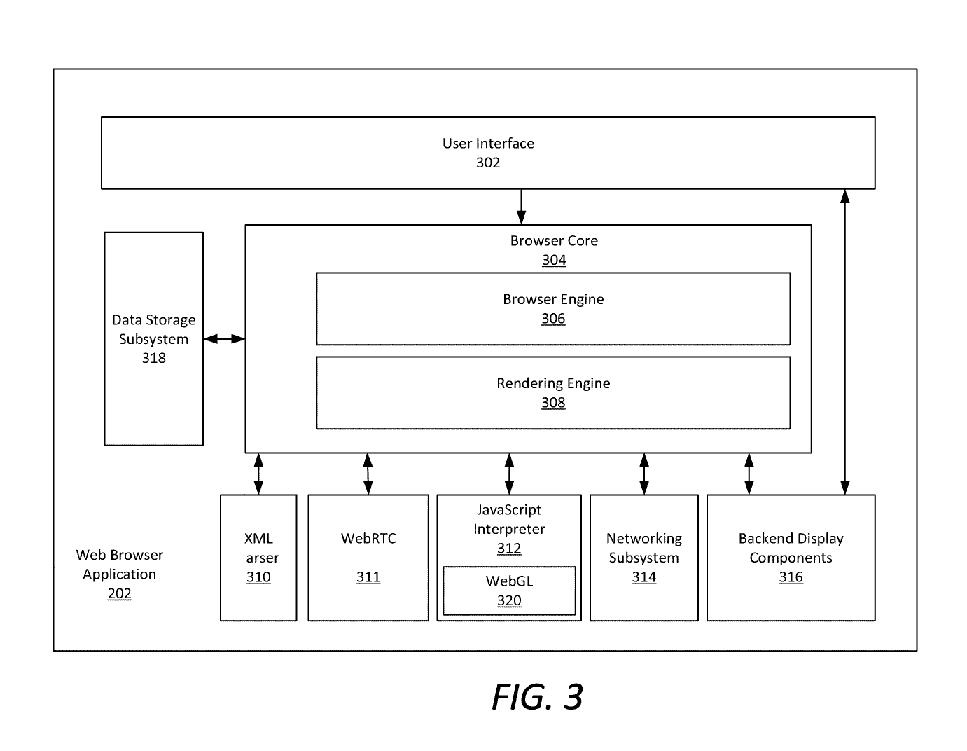

Referring now to FIG. 3, there is shown a more detailed block diagram that is useful for understanding web browser application 202 which incorporates WebRTC. Web browsers are well known in the art and many variations of different web browser are possible. Accordingly, web browser application 202 will not be described here in detail. However, a brief description of certain components included in the web browser application 202 is useful for understanding certain aspects of the invention. The web browser application 202 is comprised of a browser core 304 which includes a browser engine 306 and a rendering engine 308. The browser engine essentially serves as an interface that facilitates control and interaction between the rendering engine 308 and a user interface 302.

The user interface 302 can include various graphically displayed components (not shown) that facilitate user control over the content that is displayed by the web browser application 202. As such, the user interface can include certain control elements such as an address bar (not shown) that is used to specify web address of resources to be requested by the web browser application. The user interface 302 can also include a menu containing lists of commands that are useful for purposes of displaying web content. For example, the menu can include a bookmark menu item which, when activated shows a list of certain frequently viewed internet-based resources which can be accessed. Other control elements provided by the user interface can include a forward/back control to specify that the web application browser is to display certain previously viewed internet based resources.

The rendering engine parses HTML web pages and facilitates the display of specified content on a display (not shown) associated with the client computing device 200. For example, the rendering engine can perform certain parsing operations and can facilitate layout of HTML documents on the display. A data storage subsystem 318 is provided to facilitate storage of certain data elements that are used primarily by the web browser application. These data elements can include certain cached elements of previously viewed HTML web page resources and records associated with certain websites that have been accessed. The data storage subsystem provides access to hardware resources in client computing device 200 to facilitate storage and retrieval of data.

Other components of the web browsing application 202 include an XML parser 310, WebRTC 311, a JavaScript Interpreter 312, networking subsystem 314 and backend display components 316. The networking subsystem 314 includes software components which facilitate communications with remote web servers (e.g. that provide HTML and other media content to be displayed by the web browser application. The backend display components can include miscellaneous software components which are useful to facilitate the display of HTML web pages. As such, they can include information concerning fonts, and certain software used for drawing and supporting the user interface 302.

The JavaScript interpreter 312 (which is sometimes referred to as a JavaScript engine) is a virtual machine which interprets and executes JavaScript. The JavaScript interpreter provides access to the well-known WebGL API or software library. More particularly, WebGL extends the capability of the JavaScript programming to facilitating rendering of graphics within the web browser application 202. According to one aspect of the inventive arrangements described herein, the JavaScript interpreter 312 decodes compressed video data communicated to the client computing device 200 (e.g., video data associated with a streaming video session with an enterprise server), and displays the video using WebGL.

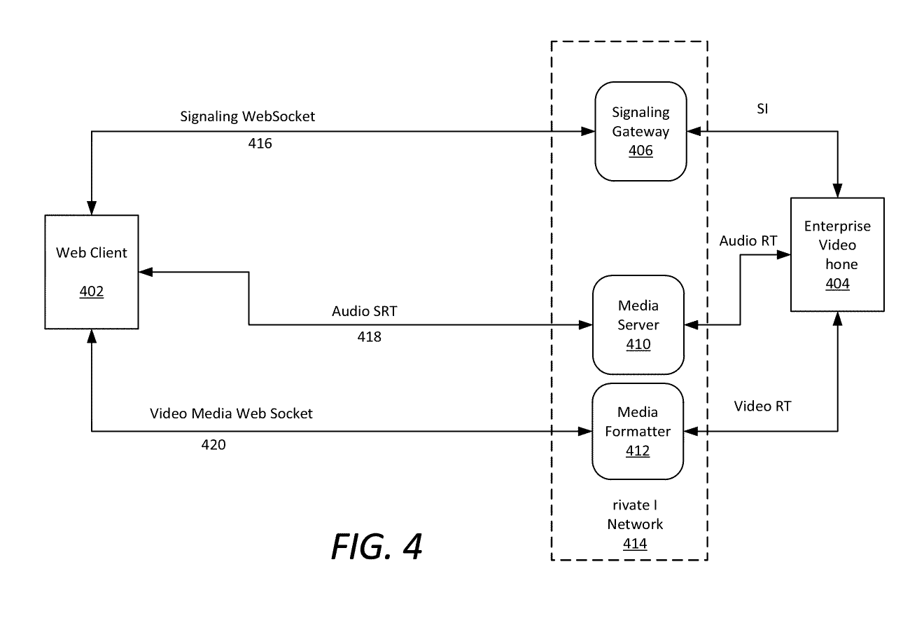

Referring now to FIG. 4, there is shown a simplified communication diagram that is useful for understanding a JavaScript framework for extending browser support of real-time media (especially video media) to any available codec, without the need for media plugins at the browser. FIG. 4 illustrates the various communications protocols involved with conducting a video media streaming session, after the necessary scripts have been downloaded from a web server and the live media call has been already setup.

In FIG. 4 there is shown a web client 402 and an enterprise video phone 404. The web client 402 and enterprise video phone 404 can be similar to the web client 200 and enterprise video phone 110 described above in relation to FIG. 1. Also shown in FIG. 4 is a signaling gateway 406, a media server 410 and a media formatter. The signaling gateway 406, media server 410 and the media formatter 412 can be part of a private IP network 414 which communicate with enterprise video phone 404 as hereinafter described

In the system shown in FIG. 4, bi-directional audio data is communicated in real time between the media server 410 and enterprise video phone 404 using a suitable data transfer protocol such as Real-time Transport Protocol (RTP). As will be appreciated by those skilled in the art, RTP defines a standardized packet format for delivering data (e.g. audio and/or video data) over IP networks. Likewise, bi-directional video data is communicated in real time between the media formatter 412 and enterprise video phone 404 using a suitable video data transfer protocol such as RTP. According to one aspect of the invention, a common computer server can be used to implement the functionality of media server 410 and the media formatter 412.

Signaling information for the video communication session is communicated between enterprise video phone 404 and the signaling gateway 406 using the well-known Session Initiation Protocol (SIP). As will be appreciated by those skilled in the art, SIP is a flexible protocol and facilitates real-time setup of multimedia sessions between two or more node participants. SIP can be used in conjunction with the well-known RTP Control Protocol (RTPCP). RTPCP facilitates real time monitoring of transmission statistics and Quality of Service (QoS) for RTP audio and/or visual data transmissions.

Communications between web client 402 and components of the private IP network 414 are conducted using a public IP network, such as the Internet. Audio data is communicated between the web client 402 and the media server 410 using Secure RTP (SRTP), which is a profile of RTP that provides cryptographic services for the transfer of payload data. SRTP is preferred for communications between media server 410 and web client 402 for security and privacy reasons. The SRTP channel is implemented by the WebRTC API. Accordingly, web browsers that support WebRTC have native facilities for supporting SRTP based audio data traffic.

Moreover, web browsers that support WebRTC will have integrated voice engines which include the iSAC and iLBC voice codecs. iSAC is a wideband voice codec used in many Voice over IP (VoIP) and streaming audio applications. Similarly, iSAC is used in many VoIP endpoints. Both codecs are included as part of WebRTC. Accordingly, a web browser application that supports WebRTC will include all the necessary codecs and data transport facilities which are needed to support the audio data portion of the video communication session. The native WebRTC audio codecs and other software are advantageously used as shown in FIG. 4 to support the voice communications portion of a video communication session. In such a scenario, operations performed by media server 410 in support of voice data communications can primarily include encryption operations associated with conversion of conventional RTP data to Secure RTP data.

As noted above, WebRTC does not support certain common video codecs (e.g. H.264) used in enterprise level video equipment. Accordingly, transcoding is often needed at some point in the communication chain to facilitate communications between enterprise video phones and the web client. Transcoding at the enterprise level is highly processing intensive, expensive and can limit call throughput. Accordingly, fully compatible coding and decoding is advantageously performed at the web client instead, such that no transcoding is required. Since WebRTC does not necessarily provide native support of certain video compression codecs (e.g., H.264 compression), and plugins are no longer supported by many browsers due to security concerns, a script and JavaScript interpreter is advantageously used for coding and decoding at the browser as hereinafter described.

According to one aspect of the invention, communication channels for real-time media (e.g. real time audio/video media) and/or signaling associated with such real time media can be implemented using functionality provided by using the WebRTC data channel API (RTCDataChannel API). The RTCDataChannel API supports a flexible set of data types and is designed to mimic the well-known WebSocket data channel protocol. Alternatively, such channels can be established using actual WebSocket procotols. In the embodiment shown in FIG. 4 a WebSocket based communication channel (video media WebSocket 420) is established for transmission of video data between the web client 402 and the media formatter 412. A WebSocket communication channel can be automatically established when the web client and the remote server (media formatter 412) respectively signal an intention to upgrade from the HTTP protocol to the WebSocket protocol. These actions are taken during their initial HTTP handshake routine. Once the WebSocket protocol is established according to conventional means, the WebSocket data frames can be continuously communicated bi-directionally (in full duplex) as between the client and server described herein.

So with the arrangement shown in FIG. 4, video data traffic between the enterprise video phone and the media formatter 412 is communicated using RTP, whereas video data traffic between the web client 402 and the media formatter 412 is communicated using video media WebSocket 420. The media formatter therefor performs minor functions needed to facilitate efficient communication of RTP video data using video media WebSocket 420. For example, such reformatting can include stripping TCP/IP and WebSocket packet headers from video data traffic (e.g., H.264 encoded video data) originating in the web browser. In the opposite transport direction, such reformatting of video data (e.g., H.264 video data) can include adding TCP/IP headers and WebSocket headers to the data packets.

In addition to the foregoing, the media formatter 412 will remove/add any additional RTP (or other) wrappers required for the media to pass across the network and be processed by either the browser or video phone. As is known, media packets are made up of encoded media within Network Abstraction Layer (NAL) Units. Each unit represents a single decodable block. When the media is passed from browser to video phone the raw NAL units from the browser are wrapped and passed onwards. Conversely, when the media is originating from the video phone, the network packets are unwrapped and the raw NAL units are passed to the browser.

In an alternative embodiment of the invention one or more of the functions performed by the media formatter 412 could optionally be performed instead at the web client browser using the script included in an HTML web page and the JavaScript engine. However, it is presently preferred that these actions be performed at the enterprise level (e.g., in a server such as the media formatter 412).

From the foregoing it will be understood that some intermediate processing is still needed in the embodiment shown to facilitate the video data communication channel described herein. However, the packet conditioning or formatting required is minimal compared to the conventional approach which involves transcoding from one video compression format to a different video compression format. Accordingly, processing demands imposed on the media formatter (which in conventional systems would perform video compression transcoding) are minimal when the inventive arrangements are utilized as described herein.

A WebSocket based communication channel (signaling WebSocket 416) can also be provided between the web client 402 and the signaling gateway 406. As with video media web socket 420, a similar WebSocket communication channel is automatically established when the web client 402 and the remote server (signaling gateway 406) respectively upgrade from the HTTP protocol to the WebSocket protocol during their initial HTTP handshake routine. Once the WebSocket protocol is established according to conventional means, the WebSocket data frames can be continuously communicated bi-directionally (in full duplex) as between the web client 402 and the signaling gateway 406.

As is known, SIP is a rich and noisy protocol used to cover a multitude of use cases in the enterprise telephony scope. The channel is considered “noisy” in the sense that a relatively large amount of data has to flow up and down the communication channel to properly implement the protocol. In the video communication scenario, SIP relies on many messages just to establish a call. It also relies on messages being sent during inactivity to provide timers and keep alives. In contrast, web browsers are more limited in their use case set and hence a more simple protocol is normally used at the browser. When this simple signaling is sent into the enterprise network it is transcoded into SIP—and equally the SIP must be transcoded to the simple protocol when passed to a web browser. This process of converting from one signaling to the other is performed on the signaling gateway 102 in the network since it is at this location in the network flow that the appropriate inputs are available.

The more simple protocol used by the web browser for enterprise telephony (including video telephony) is advantageously selected so as not to be SIP due to the unnecessary complexity of that protocol. Still, it should be understood that for purposes of the inventive arrangements described herein, any suitable signaling protocol can be used for the live-media session signaling, provided that it is sufficient to initiate, maintain and ultimately terminate the session. Notably, WebRTC intentionally does not specify a standard protocol for this purpose. WebRTC specification is explicit that the protocol for call setup should not be standardized.

As noted above, the JavaScript scripts that are downloaded to the web browser will advantageously include call setup and signaling scripts. These scripts can be separate from the codec scripts, which are also downloaded at the initiation of the call. The setup and signaling scripts can be used to establish one or more communications channels, and to initiate, maintain and terminate the live media communication session. But in order to be compliant with SIP (and to be able to call the Javascript a true SIP stack) the downloaded script for call signaling would have to cover a multitude a use cases that are irrelevant to web browsers. The script would also be required to send many additional messages to be compliant where there is no actual need. These factors would result in unnecessary and undesirable complexity being needlessly introduced into the JavaScript code that is downloaded to the web client. To avoid these issues, the downloaded script is designed to implement a relatively simple signaling protocol. Signaling gateway 406 is used at the enterprise side of the communication link to perform any needed signal transcoding. The signaling gateway 406 ensures that the relatively simple signaling protocols implemented at the web browser are transcoded to the SIP signaling used at the enterprise level (e.g., for signaling between the video phone 404 and the signaling gateway).

At call setup the web browser downloads the web page and its JavaScript scripts from the web server 114. The page is displayed and the browser's JavaScript engine executes the scripts. These scripts execute a WebSocket setup with the signaling gateway. The traditional OFFER/ANSWER call setup then takes places with the signaling gateway 406, thereby allowing the two end points to exchange codec capabilities and media port destinations. This invention would offer additional codec capabilities to the far endpoint. Each of these additional codecs are provided as JavaScript scripts running with the browser JavaScript engine.

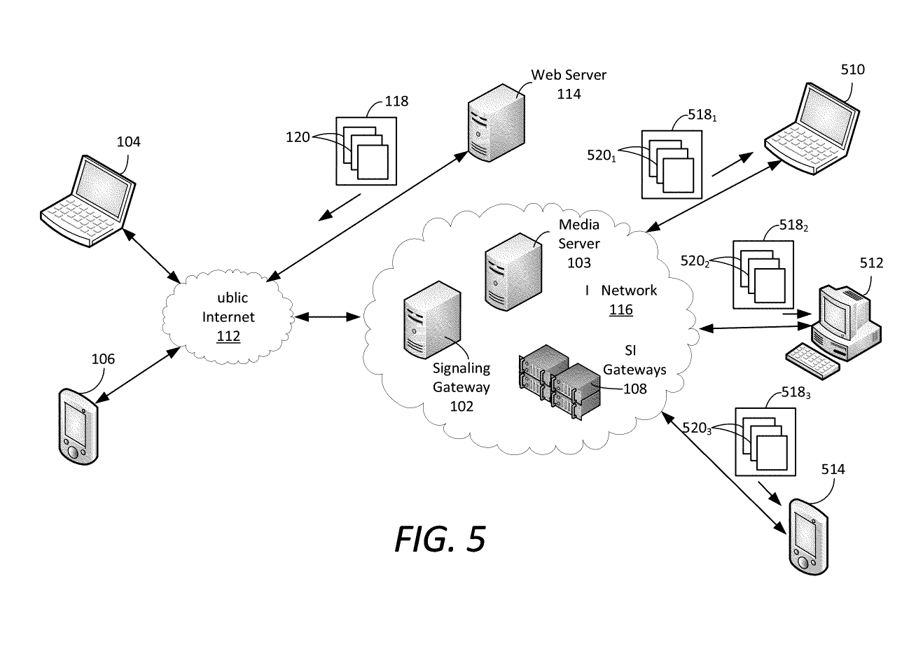

Up to this point, the inventive arrangements have been described in the context of a scenario in which an enterprise video phone 110 communicates with client side computing devices (such as laptop computer 104 and/or smart-phone 106) through IP network 116 and public internet 112. A web browser executing on the client side computing device receives a downloaded script (e.g. from a web server 114) as part of a web page and uses the script to perform codec operations for ensuring media encoding compatibility with the remote video phone 110. In such a scenario, it is assumed that a codec (e.g. an H.264 codec) used at the enterprise video phone is essentially fixed and remains unchanged for live media communication sessions with various client devices (e.g. laptop computer 104 and/or smart-phone 106). In an alternative embodiment of the invention shown in FIG. 5 one or more of the endpoint devices that participate in a live media communication session, such as a video communication session, can also be computing devices that communicate by using a web browser. In the exemplary arrangement shown in FIG. 5, the endpoint devices include laptop computer 510, desktop computer 512 and a smartphone 514. However, any other computing devices executing a web browser application can also be used for this purpose.

In the scenario shown in FIG. 5, the web server 114 and or media server 103 will receive one or more HTTP requests from enterprise side computing devices such as laptop computer 510, desktop computer 512 and/or a smartphone 514. For example, the HTTP requests can come from such devices 510, 512, 514 as they are attempting to log into a live video media streaming session. The received URL requests received at the web server 114 (or media server 103) will identify specific web pages which are to be served to such computing devices.

In response to such requests, at least one web page 518₁, 518₂, 518₃ is served which is comprised of HTML or comparable markup language. These web pages will include scripts 520₁, 520₂, 520₃ which are executable by a script interpreter or script engine associated with a web browser at laptop 510, desktop computer 512, and/or smartphone 514). For example, the scripts can be written in the well-known JavaScript language and can be interpreted by a JavaScript engine as described above. As explained above with regard to the web client devices, the scripts which are downloaded as part of the web page will advantageously include a codec for coding and decoding a live media data stream, such as a video data stream and/or an audio data stream. The scripts can also include signaling components that facilitate setup, maintenance and termination of the live media data stream as described above.

In the scenario shown in FIG. 5, a suitable JavaScript codec can be downloaded to both endpoints that are participating in a live media communication session. Accordingly, the web browser at each endpoint can be immediately extensible to any video coding or compression schemed now known or known in the future. Each of devices 510, 512 and 514 can receive a different codec suitable for participating in media sessions having a particular video data encoding formats. This arrangement provides web browsers with great flexibility for participating in live media sessions using essentially any desired media formatting. Once a suitable codec has been downloaded to each of the endpoint computing devices as described herein, communications can proceed generally as shown in FIG. 4.

A similar approach as described herein can be used to facilitate a live media session between two web client computing devices, such as laptop 104 and smartphone 106. The two web client computing devices for which a media session is to be established may not have compatible media codecs. In such a scenario, the web server 114 and or media server 103 will receive one or more HTTP requests respectively from the client computing devices. For example, the HTTP requests can come from such devices 104, 106 as they are attempting to log into a live video media communication session. The URL requests received at the web server 114 (or media server 103) will identify specific web pages which are to be served to such computing devices. In response to such requests, at least one web page 118 is served to both of the client endpoint devices (e.g. laptop 104, and smartphone 106) that seek to participate in the live media communication session. The web pages will include scripts 120 which are executable by a script interpreter or script engine associated with a web browser in each of laptop 104 and smartphone 106). For example, the scripts can be written in the well-known JavaScript language and can be interpreted by a JavaScript engine as described above. The scripts will advantageously include a codec for coding and decoding a live media data stream, such as a video data stream and/or an audio data stream. The same type of codec is advantageously downloaded to both endpoints wishing to participate in the live media communication session so that the two endpoints can participate in the communication session without the need for any transcoding.

The scripts provided to devices 104, 106 can also include signaling components that facilitate setup, maintenance and termination of the live media data stream. In such a scenario, the two participating endpoint computer devices would use communication protocols similar to those described above with respect to web client 402. For example, each of the endpoint computing devices could set up a signaling WebSocket, a video media web socket 420, and an audio SRTP data link.

The present invention can be realized in one computer system. Alternatively, the present invention can be realized in several interconnected computer systems. Any kind of computer system or other apparatus adapted for carrying out the methods described herein is suited. A typical combination of hardware and software can be a general-purpose computer system. The general-purpose computer system can have a computer program that can control the computer system such that it carries out the methods described herein. A computer program, software application, computer software routine, and/or other variants of these terms, in the present context, mean any expression, in any language, code, or notation, of a set of instructions intended to cause a system having an information processing capability to perform a particular function either directly or after either or both of the following: a) conversion to another language, code, or notation; or b) reproduction in a different material form.

A computer system or computing device as referenced herein can comprise various types of computing systems and devices, including a server computer, a client user computer, a personal computer (PC), a tablet PC, a laptop computer, a desktop computer, and/or a smartphone capable of executing a set of instructions (sequential or otherwise) that specifies actions to be taken by that device. The phrase “computer system” shall be understood to include any collection of computing devices that individually or jointly execute a set (or multiple sets) of instructions to perform any one or more of the methodologies discussed herein.

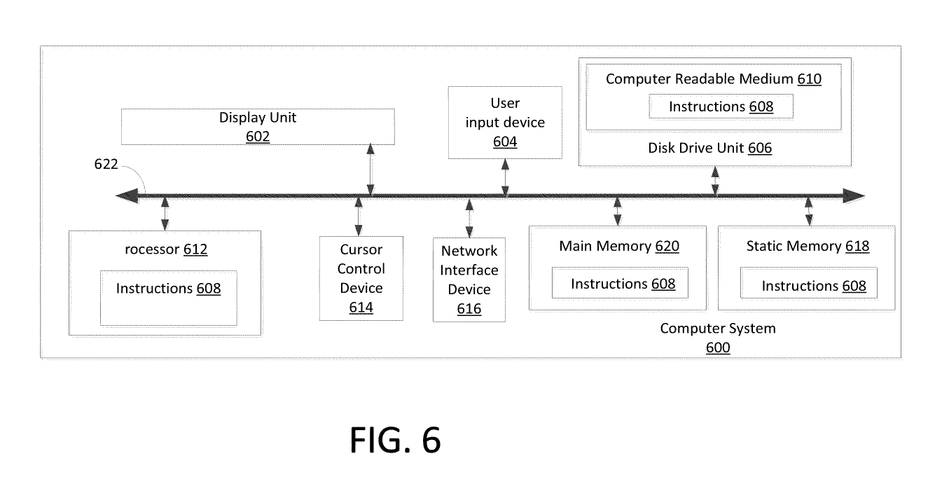

Referring now to FIG. 6, a computer system 600 includes a processor 612 (such as a central processing unit (CPU), a graphics processing unit (GPU, or both), a disk drive unit 606, a main memory 620 and a static memory 618, which communicate with each other via a bus 622. The computer system 600 can further include a display unit 602, such as a video display (e.g., a liquid crystal display or LCD), a flat panel, a solid state display, or a cathode ray tube (CRT)). The computer system 600 can include a user input device 604 (e.g., a keyboard), a cursor control device 614 (e.g., a mouse) and a network interface device 616.

The disk drive unit 606 (or an equivalent electronic memory) includes a computer-readable storage medium 610 on which is stored one or more sets of instructions 608 (e.g., software code) configured to implement one or more of the methodologies, procedures, or functions described herein. The instructions 608 can also reside, completely or at least partially, within the main memory 620, the static memory 618, and/or within the processor 612 during execution thereof by the computer system. The main memory 620 and the processor 612 also can constitute machine-readable media.

Those skilled in the art will appreciate that the computer system architecture illustrated in FIG. 6 is one possible example of a computer system. However, the invention is not limited in this regard and any other suitable computer system architecture can also be used without limitation. Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments may implement functions in two or more specific interconnected hardware modules or devices with related control and data signals communicated between and through the modules, or as portions of an application-specific integrated circuit. Thus, the exemplary system is applicable to software, firmware, and hardware implementations.

In accordance with various embodiments of the present invention, the methods described herein are stored as software programs in a computer-readable storage medium and are configured for running on a computer processor. Furthermore, software implementations can include, but are not limited to, distributed processing, component/object distributed processing, parallel processing, virtual machine processing, which can also be constructed to implement the methods described herein.

While the computer-readable storage medium 610 is shown in an exemplary embodiment to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical mediums such as a disk or tape. Accordingly, the disclosure is considered to include any one or more of a computer-readable medium as listed herein and to include recognized equivalents and successor media, in which the software implementations herein are stored.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

We claim:

1. A method for extending web browser support to include real-time media having any media compression scheme without the need for media plugins, comprising:
receiving at a web client computing device a web page resource hosted by a server, the web page resource comprising at least one embedded script which defines a codec for real-time media communications;
initiating a real-time media session as between the web client and a remote computing device;
receiving at the web client real-time media data originating from the remote computing device and encoded using a media coding scheme;
performing media decoding at the web client within a web browser application using the codec defined in the at least one embedded script to convert the video data from the media coding scheme to a non-encoded media format.

2. The method according to claim 1, further comprising encoding real-time media data originating at the web client by using the codec defined in the embedded script to convert non-encoded real-time media data to the media coding scheme.

3. The method according to claim 1, wherein the at least one embedded script is comprised of JavaScript, and further comprising executing the at least one embedded script using a JavaScript engine.

4. The method according to claim 1, wherein the real-time media includes audio and video media.

5. The method according to claim 1, further comprising establishing a WebSocket communication channel between the web client and at least one server, and performing bi-directional communication of the real-time media in an encoded form between the web client and the at least one server using the WebSocket channel.

6. The method according to claim 1, wherein the web browser application supports WebRTC and further comprising receiving at the web client a second type of real-time media which uses a second encoding scheme which is supported by at least one WebRTC codec.

7. The method according to claim 6, wherein the second type of real-time media is audio media.

8. The method according to claim 1 wherein the encoding produced by the codec defined in the embedded script comprises a data compression scheme.

9. The method according to claim 1, wherein the media encoding scheme is H.264.

10. A method for extending web browser support to include real-time media having any media compression scheme without the need for media plugins, comprising:
using a computer network to receive respectively at first and second computing devices a web page resource hosted by a server, the web page resource comprising at least one embedded script which defines a codec for real-time media communications;
initiating a real-time media session as between the first and second computing devices;
performing media coding at the first computing device within a first web browser application using the at least one embedded script to convert the video data from a non-encoded media format to an encoded media format;
using the computer network to communicate the video data having the encoded media format from the first computing device to the second computing device;
receiving at the second computing device from the first computing device the video data having the encoded media format;
performing media decoding at the second computing device within a second web browser application using the at least one embedded script to convert the video data from the encoded media format to a non-encoded media format.

11. The method according to claim 10, wherein the at least one embedded script is comprised of JavaScript, and further comprising executing the at least one embedded script using a JavaScript engine.

12. The method according to claim 10, further comprising establishing a WebSocket communication channel between the first computing device and at least one server, and performing bi-directional communication of the video data in the encoded format as between the first computing device and the at least one server using the WebSocket channel.

13. The method according to claim 10, wherein the first web browser application supports WebRTC and further comprising receiving at the first computing device a second type of real-time media which uses a second encoding scheme which is supported by at least one WebRTC codec.

14. The method according to claim 13, wherein the second type of real-time media is audio media.

15. The method according to claim 10 wherein the coding performed by the codec comprises a data compression scheme.
